(19) United States
(12) Patent Application Publication
(10) Pub. No.: US 2019/0015826 A1
(43) Pub. Date: Jan. 17, 2019

(54) ACOUSTIC MIXING AS A TECHNIQUE FOR COATING PROPELLANT

(71) Applicants: ERIK JASON ROBINETTE, WILMINGTON, DE (US); PAMELA J. KASTE, NORTH EAST, MD (US); STEPHEN L. HOWARD, NEWARK, DE (US)

(72) Inventors: ERIK JASON ROBINETTE, WILMINGTON, DE (US); PAMELA J. KASTE, NORTH EAST, MD (US); STEPHEN L. HOWARD, NEWARK, DE (US)

(73) Assignee: UNITED STATES GOVERNMENT AS REPRESENTED BY THE SECRETARY OF THE ARMY

(21) Appl. No.: 15/651,046

(22) Filed: Jul. 17, 2017

(51) Int. Cl. B01J 37/34; B01J 37/02; C06B 45/04; C06B 45/02; C06B 23/00; C06B 21/00; C08L 75/04; C08L 67/00

(52) U.S. Cl. CPC B01J 37/343; B01J 37/0201; C06B 45/04; C08L 67/00; C06B 23/001; C06B 21/0083; C08L 75/04; C06B 45/02

(57) ABSTRACT

A process for mixing two materials using acoustic energy. A first material and a second material are placed within a mixing vessel and acoustic energy is transferred to the vessel. The first material has a plurality of particles with porosity and the second material may or may not be a polymeric liquid. The acoustic energy mixes the first material and the second material, the second material coats the first material, and shear forces are created that force the second material into at least a portion of the porosity of the first material.

### CROSS REFERENCE TO RELATED APPLICATIONS

This application is a divisional of co-pending application(s) Ser. No. 14/288,717, filed in the name of Erik J. Robinette on 28 May 2014. The complete disclosure of which, in its entirety, is herein incorporated by reference.

### GOVERNMENT INTEREST

The embodiments described herein may be manufactured, used, and licensed by or for the United States Government.

### BACKGROUND

### Field of Art

The present invention relates in general to an acoustic mixing process and in particular to an acoustic mixing process for coating a first material with a second material.

### Background

The coating of propellant materials is known. For example, propellant grains are known to be coated with polymeric liquids in order to provide more environment insensitive propellants.

The majority of propellant coating techniques use a rotary mixer such as a polishing drum in order to disperse a coating material and agitate propellant grains while the coating material cures or dries. In addition, current coating technology relies on spray-based technology to deliver the coating material into the rotary drum. With the use of such spray-based technology, low viscosity, free-radical curing polymers are used for coating materials. However, such low viscosity coatings are typically a combination of low molecular weight components, with or without a solvent, and such liquids have been shown to swell propellant grains and thus alter their designed composition. Therefore, a mixing technique that affords for the use of higher viscosity polymeric liquids that avoids or overcomes the above-stated problems would be desirable.

### SUMMARY

The present invention provides a process for mixing two materials. In addition, the mixing of the two materials results in one material coating the other. The process includes providing a mixing vessel and providing a first material and a second material. The first material has a plurality of particles, some of which may have porosity, and the second material may or may not be a polymeric liquid. The first material is placed into the mixing vessel, as is the second material. An acoustic energy source is also provided and affords for transference of acoustic energy to the mixing vessel, the first material, and the second material. The acoustic energy mixes the first material and the second material so that the first material is coated by the second material. Under certain conditions, this process has the ability to force at least a portion of the second material into the porosity of the first material.

In embodiment, the second material may, for example, comprise a polymeric liquid and the plurality of particles are coated by the liquid. In addition, the polymeric liquid can have an initial viscosity of at least 15 centipoise (cP), and can illustratively include liquids such as an epoxy, an acrylate, a polyurethane, a polyurea, a polyester, a vinyl ester, a phenolic, a silicone, combinations thereof, that may also be modified with additives such as dyes, fluorescent and/or phosphorescent tags to facilitate analysis.

The plurality of particles can be a plurality of propellant grains and the porosity can be at least one perforation. For example, the plurality of grains can be a plurality of propellant grains that have a design channel or perforation along the axis of the grain as is known to those skilled in the art.

The process can also include a filler medium in addition to the plurality of grains to be coated. The filler medium can be glass particles, polymer particles, wood particles, metal particles, inorganic and/or ceramic particles, and/or combinations thereof.

In some instances, the second material is a plurality of metal particles and the acoustic energy forces the plurality of metal particles into the porosity of the first material. In addition, the plurality of metal particles may comprise a plurality of catalytic particles. Also, the first material may comprise a plurality of porous metal particles and thus the acoustic energy forces the plurality of catalytic particles into the porosity of the metal particles.

In other emobiments, the first material may comprise a structured matrix form and the second material may comprise an active material. As such, the acoustic energy forces the active material into the porosity of the first material and the active material has or takes the form of the structured matrix. Optionally, the first material is removed, thereby leaving only the active material with the form or shape of the structured matrix. The first material can be removed by any method or technique known to those skilled in the art such as dissolution.

In yet other embodiments, the first material may comprise a filter media material and the second material may comprise an air-quality improvement material. The air-quality improvement material can illustratively include titanium dioxide (TiO₂), nano-crystalline silver, a thiol, inert or activated carbon, chromatographic substrates, combinations thereof, etc. In such instances, the acoustic energy forces the air-quality improvement material into the porosity of the filter media material to provide an air-quality improvement component/filter.

In still yet other embodiment, the first material may comprise a biomaterial and the second material may comprise an enzyme and/or a catalyst, receptor and/or ligand, and nucleotides. In such instances, the enzyme and/or catalyst is forced into the porosity of the biomaterial such that bioremediation or physiochemical degradation into precursor substances used for biofuel production are provided.

### BRIEF DESCRIPTION OF THE DRAWINGS

FIG. 1 is a schematic illustration of a process according to an embodiment of the present invention;

FIG. 2 is a schematic illustration of a process according to another embodiment of the present invention;

FIG. 3 is a schematic illustration of a first material being coated by a second material according to an embodiment of the present invention;

FIG. 4 is a graphical plot of viscosity versus mixing time for two polymeric liquids;

FIGS. 5A, B, C, D and E are a series of optical micrographs showing end views of propellant grains with different levels of perforation coverage by a high viscosity polymeric liquid;

FIGS. 6A and B are a pair of scanning electron microscopy (SEM) images of radial cross-sections for coated propellant grains having a nominal coating thickness of approximately 50 microns;

FIGS. 7A, B, and C are a series of SEM images of radial cross-sections for coated propellant grains having a nominal coating thickness greater than 50 microns; and

FIGS. 8A and B are a series of SEM images of radial cross-sections for coated propellant grains having a nominal coating thickness greater than 100 microns.

### DETAILED DESCRIPTION

A process for mixing two materials using acoustic energy so that one material coats the other material is provided. In addition, the mixing process can be designed so that the acoustic energy results in or forces at least part of the one of the materials into porosity of the other material. The acoustic energy also affords for the second material to be a liquid such as, for example, a polymeric liquid and for the liquid to have a viscosity that is much greater than heretofore known liquids used to coat and at least partially fill porosity of a first material.

The process includes providing a mixing vessel and an acoustic energy source that is operable to transfer acoustic energy to the mixing vessel. The process also includes providing a first material that has a plurality of particles, some of which may have porosity, and placing the first material into the mixing vessel. A second material is also provided and placed into the mixing vessel. Transference of acoustic energy from the acoustic energy source to the mixing vessel, the first material and the second material affords for mixing of the two materials together so that a sufficient coating of the first material with the second material is achieved. Processing conditions may be designed so that at least a portion of the second material is forced into the porosity of the first material. In some instances, the initial viscosity of a polymeric liquid that serves as the second material may be, for example from about at least 15 cP, to about 5000 cP. With the process affording for the use of high viscosity liquids, polymeric liquids such as an epoxy, an acrylate, a polyurethane, a polyurea, a polyester, a vinyl ester, a phenolic, a silicone, combinations thereof, and the like can be used to coat particles of a first material. In addition, the acoustic energy creates shear forces between the first material and the second material such that the high viscosity liquid is forced into at least a portion of the porosity of the first material.

A particularly useful application of the current invention is for the coating of propellant grains. Stated differently, the first material is in the form of a plurality of propellant grains. In addition, once the propellant grains and a desired high viscosity polymeric liquid are placed within the mixing vessel, the acoustic energy affords for uniform coating of the grains with the polymeric liquid. In addition, the acoustic energy can force the liquid at least partially within any porosity that is within each grain.

In addition to the plurality of particles to be coated, a filler medium can also be placed within the mixing vessel. The filler medium can be glass particles, polymer particles, wood particles, metal particles, inorganic and/or ceramic particles such as silica, alumina, titania, calcium carbonate, combinations thereof, and the like.

With respect to the coating of propellant grains, it is appreciated that such grains are processed or manufactured with perforations in the form of hollow channels being present along the axial length of a propellant grain. The purpose of the perforation is to control burning behavior of the propellant. It is also appreciated that coating of at least a portion of the perforation can provide improved temperature compensation of the propellant during ignition. However, current spray-based propellant coating technologies do not allow for processing of high viscosity polymers, thereby limiting the choice of coating materials, nor do they provide shear forces that are great enough to drive or force a coating material into the propellant grain perforation and thus such benefits of temperature compensation are not currently realized.

In contrast, the inventive process with the use of acoustic energy disclosed herein provides shear forces that not only disperse and afford for coating of materials with high viscosity and solvent-less coatings, but also affords for driving or forcing a polymeric liquid into porosity of propellant grains.

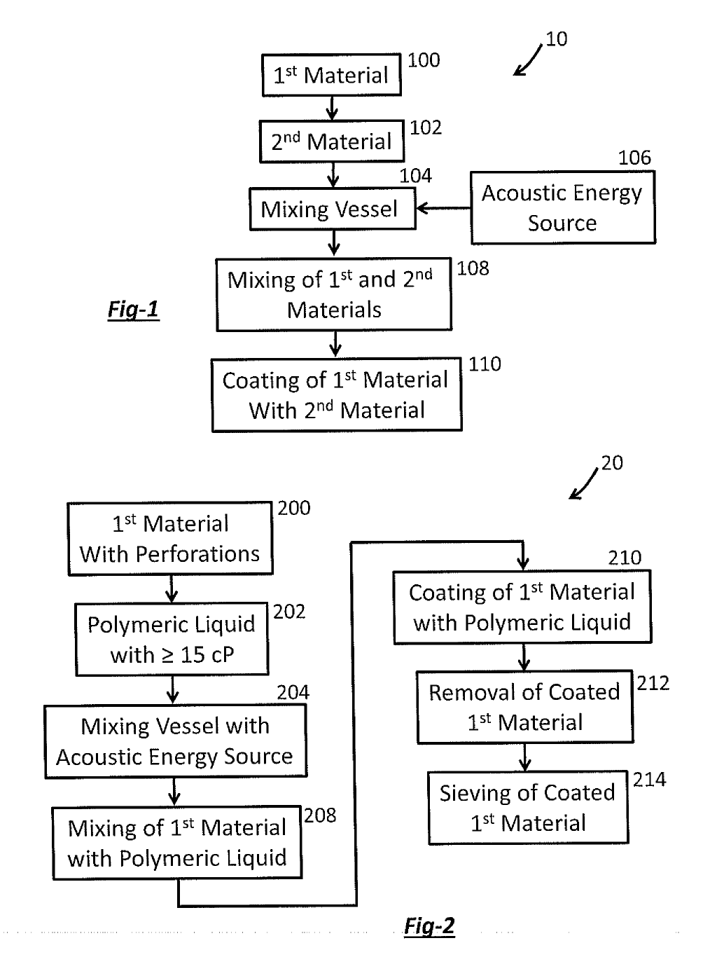

Turning now to FIG. 1, a process according to an embodiment of the present invention is shown generally at reference numeral 10. The process 10 includes providing a first material at step 100 and a second material at step 102. A mixing vessel is provided at step 104 and an acoustic energy source at step 106. It is appreciated that the acoustic energy source 106 is operable to provide and transfer acoustic energy to the mixing vessel 104 and any material therein. The first material and second material are placed within the mixing vessel and the materials are mixed therein at step 108 by the transfer of acoustic energy from the acoustic energy source to the mixing vessel. At the point of where the second material dries or reaches a gelatinous state in the cure, the second material is uniformly coated by the second material at step 110.

FIG. 2 provides an illustration of another process according to an embodiment of the present invention at reference numeral 20. The process 20 refers to the coating of propellant grains. Propellant grains with perforations are provided at step 200. A high viscosity polymeric liquid having an initial viscosity greater than 15 cP is provided at step 202 and a mixing vessel with an acoustic energy source is provided at step 204. In other embodiments, the high viscosity polymeric liquid has an initial viscosity greater than 50 cP, or in the alternative greater than 75 cP. The propellant grains and the polymeric liquid are placed within the mixing vessel, and with the application of acoustic energy, the propellant grains and the polymeric liquid are mixed at step 208. As stated above, shear forces created between the polymeric grains and the polymeric liquid can force liquid into porosity of the grains at step 210 if so desired. At step 212, the coated propellant grains are removed from the mixing vessel. Other steps can be included such as sieving of the coated propellant grains at step 214. Also, separation of the coated propellant grains from an optional filler media can be included.

Turning now to FIG. 3, a schematic illustration of a first material being coated by a second material is shown generally at reference numeral 30. A first material 300 has porosity 302 in the form of a perforation, the perforation 302 having an outer surface or interface 304. A second material 310, e.g. a high viscosity polymeric liquid, is placed in contact with the first material 300 and acoustic energy as represented by the double-headed arrows shown in the figure create a shear force between the first material 300 and the second material 310. The shear force results in the second material 310 traveling or being forced along the surface of the first material 300 as illustrated by the arrows 312 in the figure. In this manner, particles, grains, etc. having a variety of shapes, configurations, and the like can be coated with high viscosity liquids. In addition, porosity of such particles, can also be coated and/or filled by the high viscosity liquid.

In order to further teach the invention, and yet not limit its scope in any way, one or more examples are discussed below.

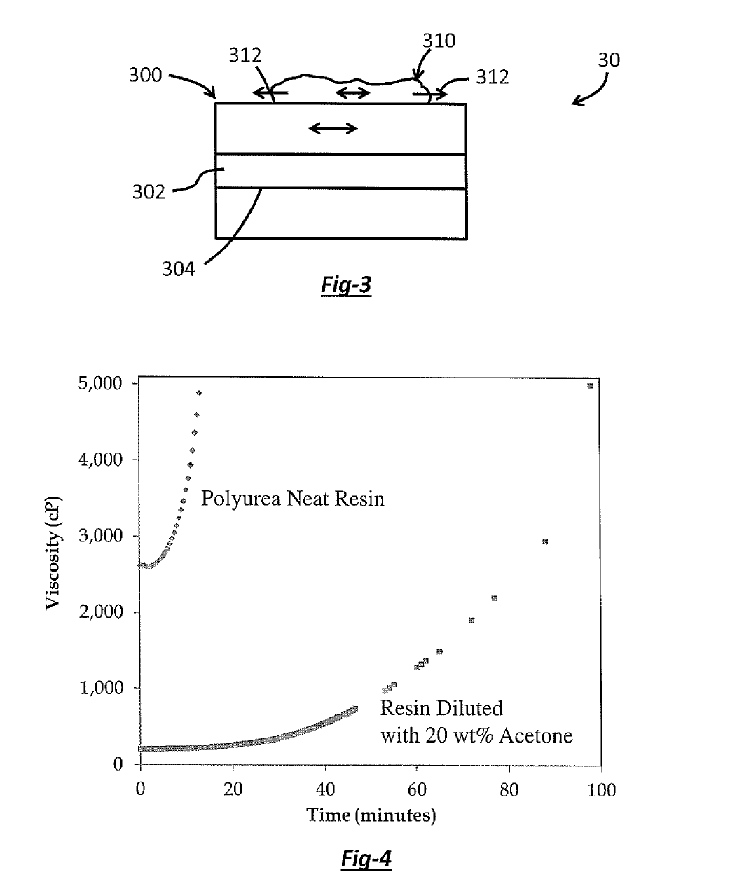

A LabRAM from Resodyn Acoustic Mixers, Butte, Montana, was used as a mixing vessel and a source of acoustic energy. Propellant grains and polyurea were placed within the LabRAM and mixed for times ranging from about 1 to about 20 minutes. FIG. 4 provides a graphical plot of the viscosity of the polyurea as a function of mixing time along with a low viscosity mixture containing or diluted with 20 weight percent acetone. It is appreciated that the diluted mixture is typical of prior art mixing processes and techniques and the use of such high viscosity polymeric liquids having viscosities equal to or greater than about 745 cP to coat propellant grains and at least partially fill porosity within such grains is not known.

Results of such mixing trial runs are shown in FIGS. 5-8. For example, FIGS. 5A-5E provide optical micrographs of end views for propellant grains with different levels of perforation coverage. As shown in the micrographs, the perforation coverage was a function of the amount of polymeric liquid placed within the mixing vessel as indicated by its weight shown on the micrographs. Stated differently, the micrograph showing 3.70 gm was for a trial that had the least amount of polymeric liquid whereas the micrograph showing 15 gm was for a trial run with the most amount of polymeric liquid.

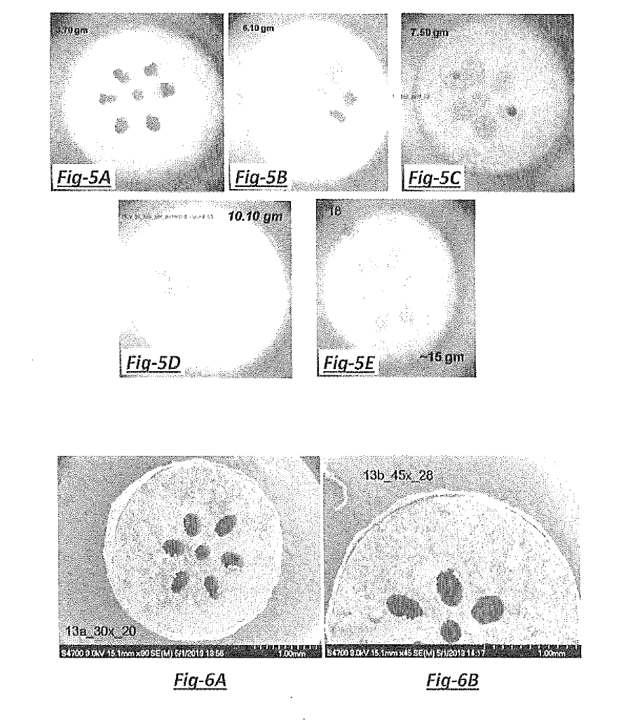

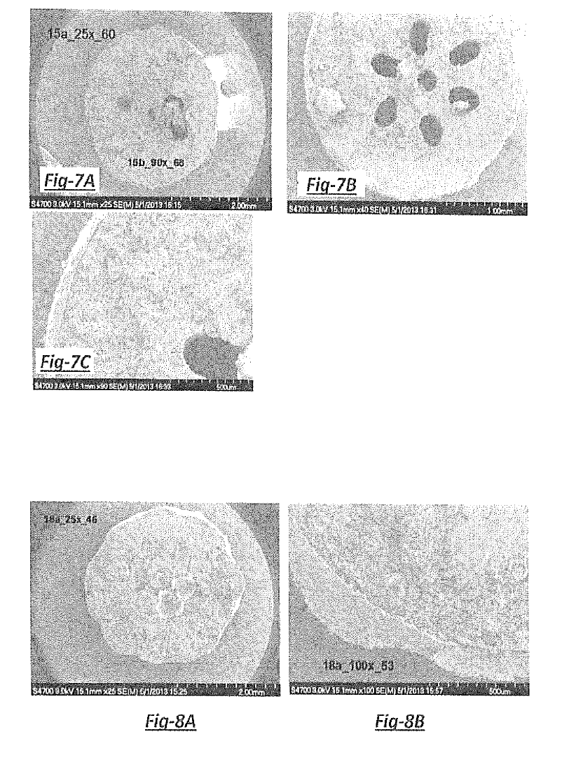

FIG. 6 illustrates scanning electron microscopy micrographs of radial cross sections for propellant grains that had a nominal coating thickness of approximately 50 microns. FIG. 7 also shows scanning electron micrographs for propellant grains with nominal coating thicknesses greater than 50 microns. Finally, FIG. 8 illustrates scanning electron micrographs of propellant grains with nominal coating thicknesses greater than 100 microns.

The trial runs showed that a higher liquid to solid ratio influences the processing behavior inside of the LabRAM mixing vessel, particularly as the viscosity of the coating liquid increased. For example, the dispersion time increased with increasing liquid content and the liquid content also influenced the bulk flow field within the mixing vessel. During agitation, i.e. once the coating liquid was delivered into the mixing vessel, a bulk mixing flow field forced the mixing components into contact with the mixing vessel wall. As such, a liquid film containing the coating material formed on the vessel wall with solid components adhered thereto. A monolayer of solid mixing medium formed on the vessel wall, however active mixing still occurred inside the vessel within this monolayer. The monolayer is referred to as a sacrificial layer in that the material remains adhered to the vessel wall through the process. The presence of more coating liquid within the mixing vessel showed more liquid accumulation on the mixing vessel wall beyond the initial sacrificial monolayer. In fact, with larger amounts of liquid, multiple layers of adhered solid contact were present.

Simulations were also performed in order to model a plurality of coating runs. For example, Table 1 below provides results for seven (7) simulated runs where percent weight uptake for propellant grains were calculated. In addition, good agreement was observed between simulations and actual experimental runs.

The simulations used a 125 mL mixing jar, a fill height of the mixing jar of apprximateloy 75% and an acoustic intensity of 70%. The first material was five (5) grams of an inert propellant having a perforated cylindrical grain size of 2.5 mm OD and a length to diameter ratio of 1.0. The remainder of mixing media to achieve the 75% fill height was 1 mm diameter glass spheres. Finally, the second material was polyurea.

Weight percent uptake (Wt. % Uptake), also referred to as percent weight uptake, was defined as the weight of the coated first material after the coating run (final weight), minus the weight of the first material before the coating run (initial weight), divided by the initial weight, times 100. As shown in the table, weight percent uptakes between 0.88 and 11.06 were simulated. In addition, the inventive process disclosed herein can provide weight percent uptakes between 0.1 and 10.0%.

TABLE 1

| | Material 1 | Material 2 | Wt. % Uptake |
|---|---|---|---|
| Simulation No. | (gm) | (gm) | (%) |
| 1 | 120.30 | 1.50 | 0.88 |
| 2 | 119.69 | 3.10 | 2.58 |
| 3 | 130.20 | 3.10 | 3.70 |
| 4 | 120.10 | 4.20 | 5.12 |
| 5 | 119.80 | 5.20 | 7.46 |
| 6 | 105.19 | 7.50 | 8.65 |
| 7 | 119.50 | 10.10 | 11.06 |

Parameters that are important to the inventive process include: (1) the liquid to solid ratio of material placed within the mixing vessel; (2) the viscosity of the coating material; (3) use of a filler medium in the mixing vessel; (4) the fill height of the mixing vessel; and (5) the acoustic mixing intensity. Other aspects that can be considered during the process are: (a) how the coating liquid is supplied or placed within the mixing vessel; (b) the use of a vacuum to remove air or solvent from the mixing vessel; (c) the use of a UV-curing lamp for UV-curable coatings; (d) the use of a thermal jacket for curing of coatings at temperatures other than room temperature, and (e) particle size of the filler medium. It is appreciated that such processing variables influence several aspects of the coating including coating thickness, depth of porosity penetration, coating roughness, and degree of propellant aggregation.

With respect to the liquid to solid ratio of material placed within the mixing vessel, this ratio is critical to controlling the coating thickness and the depth of porosity penetration. For example, as the liquid content increases within the mixing vessel, the coating thickness increases and penetration into the porosity also increases. The liquid can be added to the mixing vessel in a multitude of ways or methods, such as being top loaded into the vessel, bottom loaded into the vessel, loaded in through the middle of the vessel, added drop-wise, and/or delivered via a syringe pump for controlled constant flow rate delivery. It is appreciated that the process affords for high viscosity coating materials to be used, however it should be appreciated that low viscosity liquids, fluids, and solid and/or particulate coating materials can also be incorporated or used herein.

With regard to viscosity of the coating liquid, increasing the viscosity has the same general effect as increasing the liquid to solid content ratio. The dispersion time of the coating increased with increased viscosity and the thickness of the sacrificial layer increases with increasing viscosity. It is appreciated that to reduce the thickness of the sacrificial layer the coating liquid can be mixed with solvents and the solvent subsequently removed using a vacuum during processing. Also, and in contrast to increasing the liquid to solid ratio, penetration depth into porosity of the propellant grains decreased with increasing viscosity.

The choice of filler medium was also found to be an important aspect of the acoustic mixing process. The filler medium had two effects on the processing, including dispersion and creation of micro-mixing zones throughout the mixing medium and preferential segregation to form the sacrificial layer on the vessel wall. The size and density of the filler medium was also found to be critical. The filler medium preferably has less mass than propellant grains which affords for a greater potential to adhere to the liquid layer formed at the vessel wall. Also, the size of individual filler medium particles is desirably smaller in relation to the propellant grain size, the smaller size reducing aggregation of propellant grains. It was also found that the size and density of the filler medium impacted the surface roughness of the propellant grain coating. Finally, significant aggregation of propellant grain occurred when an undesirable filler medium, or no filler medium at all, was used.

Regarding the fill height of the mixing vessel, it was found that an adequate fill height was required in order to propagate acoustic waves into the mixing medium. Stated differently, if the volume of material within the mixing vessel fell below a critical level, the acoustic energy transferred to the mixing medium was not sufficient to overcome adherence of solid components to the liquid layer formed on the mixing vessel side wall. The formation of the sacrificial layer on the mixing vessel wall was also related to fill height and an over-fill container yielded excessive coating material on the top and bottom walls of the mixing vessel.

With respect to acoustic mixing intensity, the acoustic energy/mixing intensity is used to initially disperse the liquid coating material throughout the solid mixing medium such as propellant grains. Once dispersed, the acoustic mixing intensity reduces aggregation of the solid medium. The acoustic intensity can also influence surface roughness of a coating on the propellant grains, whereas the filler medium can have an etching effect on the propellant surface. It is appreciated that the mixing zone within the vessel must be agitated until the coating dries or cures and sufficient acoustic mixing intensity is required for this criterion.

Although the examples described above are for the coating of propellant grains, it is appreciated that the acoustic mixing process disclosed herein can be used to insert material into narrow-channel openings of materials such as carbon nanotubes, fullerenes, and the like. The insertable material can be a liquid, however can also be a solid such as fine powders/particles. The process also affords for the insertion of material into cracks, voids, perforations, channels, and/or other regions of exposed surfaces. As such, materials deemed to be unusable due to micro- or mega-scale cracks can be healed or filled with a desired material so that such materials can be used. In the alternative, improved precursors can be provided for manufacturing processes. For example, metal coatings applied by processes such as cold spray can depend on the level of co-mingling of precursor components. In addition, the inventive process allows for the ability to drive or force small metal particles into larger particle micro-cracks or pores and provide customized particle or grain compositions that can be used in such processes.

Inert as well as energetic materials can be used in the process such that liquid or solid materials can be inserted into nano-, micro-, or meso-porous substrates for such purposes as, but not limited to, enhanced catalytic activity.

Energetic crystalline compounds such as RDX, HMX, Fox-12, Fox-7, CL-20, and the like known to those skilled in the art can be coated with the inventive process prior to propellant processing and thus improve the insensitive munition behavior of such materials. In the alternative, active materials defined as biomaterials, gels, inorganic or ceramics, or metallic precursors can be inserted into porous nano-, micro-, or meso-structured matrices for production of inverse-matrix formed high-value materials. Stated differently, a first material having a desired structured matrix can be at least partially filled with a biomaterial, gel, inorganic, ceramic, or metallic precursor such that the material takes the form of the structured matrix. Thereafter, the first material can be optionally degraded and/or removed such that the second material remains with the structured matrix form.

The crystal structure of inert and energetic crystalline compounds can be modified via the acoustic energy input in a controlled precipitation process. Prior art has shown that by varying solvent and cosolvent parameters such as temperature, rate of solvent removal, and ratio of solvent to cosolvent to tailor crystal structure. With this mixing technique, another parameter for controlling crystal structure is the addition of acoustic energy along with temperature, rate of solvent removal, and ratio of solvent to cosolvent.

Air-quality improvement materials can also be provided by the inventive process with porous and/or fibrous filter media at least partially filled with materials such as TiO₂, nano-crystalline silver, thiols, inert and activated carbon and/or charcoal, chromatographic packings and the like. Such materials can be used to enhance indoor air quality in environments such as, but not limited to, hospitals; public transportation vehicles such as airplanes, trains, etc.; and other high-occupancy structures. The process can also be used to insert materials such as enzymes, catalysts, etc. into porous or fibrous biomaterials for bioremediation, assays, or physiochemical degradation into precursor substances for biofuel production.

In summary, the inventive process affords for coating of a first material with a variety of polymeric coating liquids that have a variety or variation of viscosity, cure chemistry, and cure conditions. The process also affords for control of porosity penetration of the coating and allows for highly controlled reaction conditions within a mixing vessel. The surface roughness of a coating can also be tailored and the process can be adjusted for use on small, medium, large caliber gun, mortar, and artillery propellants. Finally, the process affords for the adjustment of coating thickness and tunable surface structure.

Changes, modifications, and the like will be apparent to those skilled in the art and yet fall within the scope of the invention. As such, the scope of the invention is defined by the claims and all equivalents thereof.

We claim:

1. A process for mixing two materials, the process comprising:
providing a mixing vessel;
providing a first material;
placing the first material into the mixing vessel;
providing a second material;
placing the second material into the mixing vessel;
providing an acoustic energy source and transferring acoustic energy from the acoustic energy source to the mixing vessel, the first material and the second material, the acoustic energy mixing the first material with the second material and coating the first material with the second material.

2. The process of claim 1, wherein the first material has porosity, the second material is a plurality of metal particles and the acoustic energy forces the plurality of metal particles into the porosity of the first material.

3. The process of claim 8, wherein the plurality of metal particles are a plurality of catalytic particles.

4. The process of claim 9, wherein the first material is a plurality of porous metal particles.

5. The process of claim 1, wherein the first material has a structured matrix and the second material is an active material.

6. The process of claim 11, further including removing the first material and leaving the active material, the active material having a form of the structured matrix.

7. The process of claim 12, wherein the first material is removed by dissolution.

8. The process of claim 1, wherein the first material is a filter media material and the second material is an air-quality improvement material.

9. The process of claim 14, wherein the air-quality improvement material is selected from the group consisting of TiO₂, nano-crystalline Ag and a thiol.

10. The process of claim 1, wherein the first material is a biomaterial and the second material is selected from the group consisting of an enzyme and a catalyst.

11. A process for coating propellant grains, the process comprising:
providing a mixing vessel with an acoustic energy source;
providing a plurality of propellant grains;
placing the propellant grains into the mixing vessel;
providing a polymeric liquid;
placing the polymeric liquid into the mixing vessel; and
transferring acoustic energy to the mixing vessel, the propellant grains and the polymeric liquid, the acoustic energy mixing the propellant grains with the polymeric liquid material and coating the propellant grains with the polymeric liquid.

12. The process of claim 17, wherein the polymeric liquid has a viscosity of at least 15 cP.

13. The process of claim 18, further including adding a filler medium into the mixing vessel, the filler medium having a density and particle size less than the propellant grains.

14. The process of claim 19, wherein a weight uptake by the propellant grains is between 0.1-10 wt %.
